(19) United States
(12) Patent Application Publication
(10) Pub. No.: US 2012/0139857 A1
(43) Pub. Date: Jun. 7, 2012

(54) Gesture On Touch Sensitive Input Devices For Closing A Window Or An Application

(75) Inventors: Taras Gennadievich Terebkov, Saint Petersburg (RU); Jerome Elleouet, Lannilis (FR)

(73) Assignee: ALCATEL LUCENT, Paris (FR)

(21) Appl. No.: 13/322,748

(22) PCT Filed: Jun. 19, 2009
(86) PCT No.: PCT/RU2009/000308

§ 371 Date: Feb. 9, 2012

(51) Int. Cl. G06F 3/041

(52) U.S. Cl. 345/173

(57) ABSTRACT

A method for closing an active window or an application on a user device via detection of a user input gesture on a touch sensitive input device of said user device comprises a step of detecting touch input data with respect to the touch sensitive input device, a step of interpreting said touch input data , such that, in case said touch input data is recognized as corresponding to a gesture of forming an X-shape on said touch sensitive input device with said touch sensitive input device being oriented in a normal reading position, the active window or running application will be closed. A user device on which said method is implemented is disclosed as well.

The present invention relates to a method to be used on user devices comprising a touch sensitive input device, with the aim of closing the active window or the application on said user device.

Touch sensitive input devices such as touch pads or touch screens become more and more available in all kinds of consumer and processing devices, which are hereafter denoted as user devices. Amongst these user devices there are mobile phones, personal digital assistant devices abbreviated by PDA's, camera's, gaming devices, positioning devices, computers, . . . , even household devices comprising controllers and a touch screen can be considered as belonging to this group of user devices. Several applications can run in parallel e.g. on a processing unit such as a processor comprised in these devices. By way of example on a processor comprised in a computer several applications such as an internet session, an email session and a text editing application may all be open in parallel via several windows. Similar considerations apply for advanced mobile phones and PDA's. A processing unit within a camera is able to open several pictures or movies which are accordingly displayed on the touch sensitive display via several sub-screens or windows. Positioning devices can show several maps or details by means of several windows.

In present touch screen devices, the act of closing the present active window has to be done either via touching a specific button on the user device, or by pressing a key on the keypad, or by touching a specific field in the screen, which may e.g. be visualized by a small box enclosing a cross. Some other specific gestures for closing a window have also been proposed.

It is an object of the present invention to provide another method for closing the active window or application, which is simple, intuitive and easy understandable by everyone.

According to the invention said method comprises a step of detecting touch input data with respect to the touch sensitive input device, interpreting said touch input data, such that, in case said touch input data is recognized as corresponding to a gesture of forming an X-shape on said touch sensitive input device with said touch sensitive input device being oriented in a normal reading position, the active window or running application will be closed.

This presents a universal and easy to understand method, as the “x” sign is already nowadays understood by a lot of end-users of processing apparatus and computers as indicating the end of an operation. By letting the user form this sign on a touch screen or touch pad of his or her user device, and by the interpretation of this user device of this gesture and subsequent closure of the active window, a very simple method is obtained.

This gesture may comprise the act of writing or drawing a cross in an “x” shape, thus comprising the act of either sequentially generating two substantially diagonal lines, of about similar length, or of generating in one move an X-like shape, such as these depicted in the accompanying pictures. The individual length of these lines can range from either being rather small, to the total diagonal width of the touch screen or touch pad itself. In an embodiment the opening angles of the “x” in the horizontal directions may be substantially the same, and can comprise values between 45 and 135 degrees. Similarly in other embodiments the opening angles of the “X” in the vertical directions may be substantially the same, and can also comprise values in that range. As mentioned other method embodiments for realizing an X or cross-shape comprise a single movement gesture , thus without lifting a pen or stylus or finger or other input moving device, for realizing an x-shape on the touch screen as further explained and shown in the figures of this patent application.

The present invention also relates to a downloadable software program for implementing this method on an end-user device, to a data storage device encoding the program in machine-readable and machine-executable form, to a computer and/or other hardware device programmed to perform the steps of the method. The present invention relates as well to a sser device comprising a touch sensitive input device for receiving user input touch gestures, and a processing unit for running an application or an operating system related to at least one active window, said processing unit being further adapted to detect touch input data with respect to said touch sensitive input device and to interpret said touch input data such that, in case said touch input data is recognized as corresponding to a gesture of forming an X-shape on said touch sensitive input device with said touch sensitive input device being oriented in a normal reading position, the active window or running application will be closed.

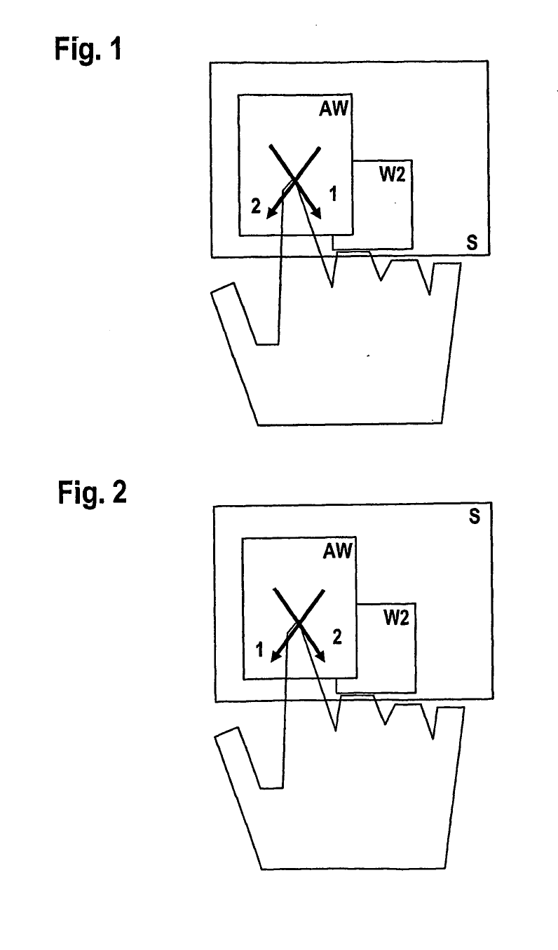

The above and other objects and features of embodiments of the invention will become more apparent and the invention itself will be best understood by referring to the following description of embodiments taken in conjunction with the accompanying drawings wherein: FIG. 1 depicts a first embodiment of the method for generating an X-shape on a touch-sensitive input device for accordingly closing the active window,

FIG. 2 depicts a second embodiment of the method for generating an X-shape on a touch-sensitive input device for accordingly closing the active window ,

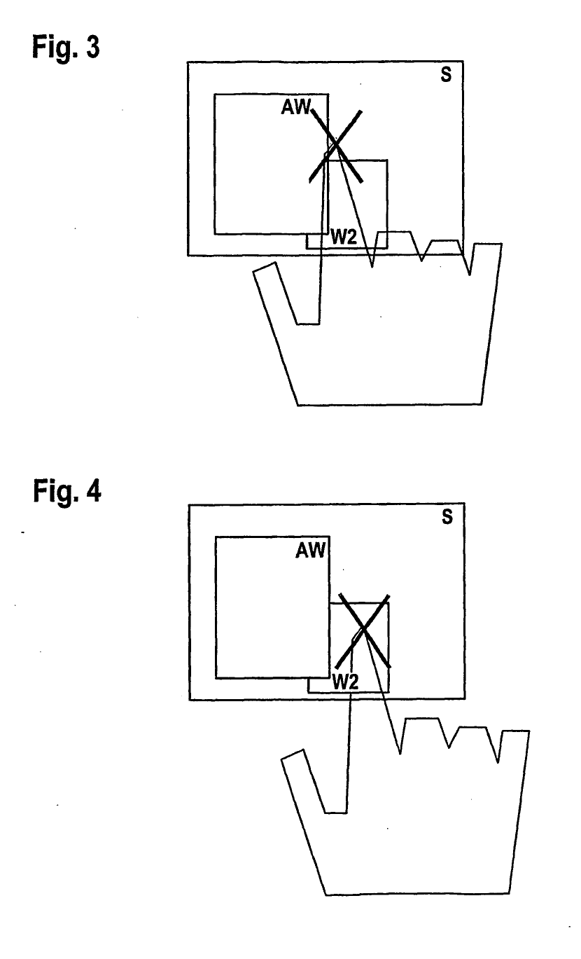

FIG. 3 depicts another embodiment of the method ,

FIG. 4 depicts still another embodiment of the method ,

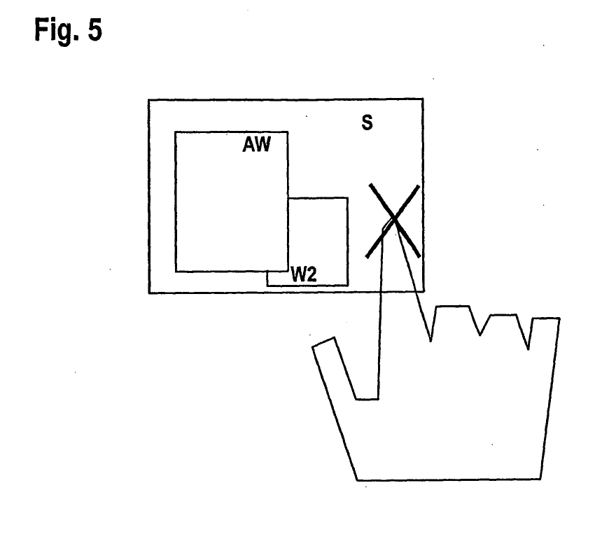

FIG. 5 depicts another variant embodiment of the method ,

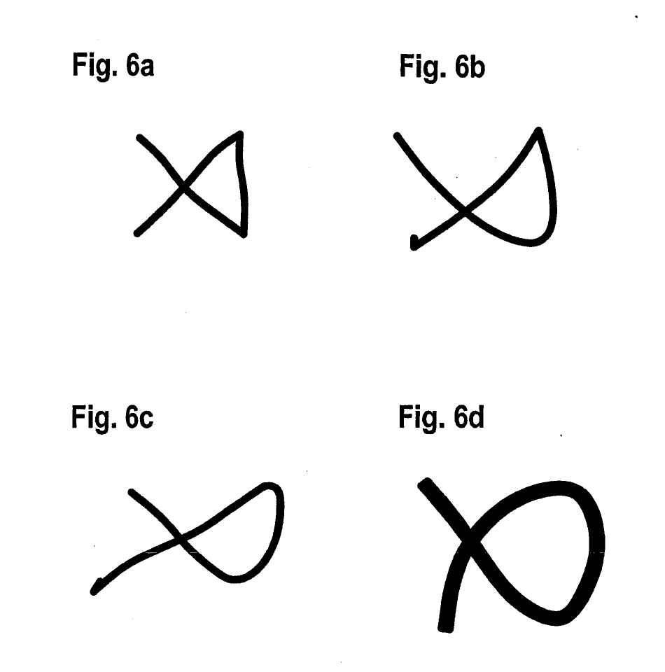

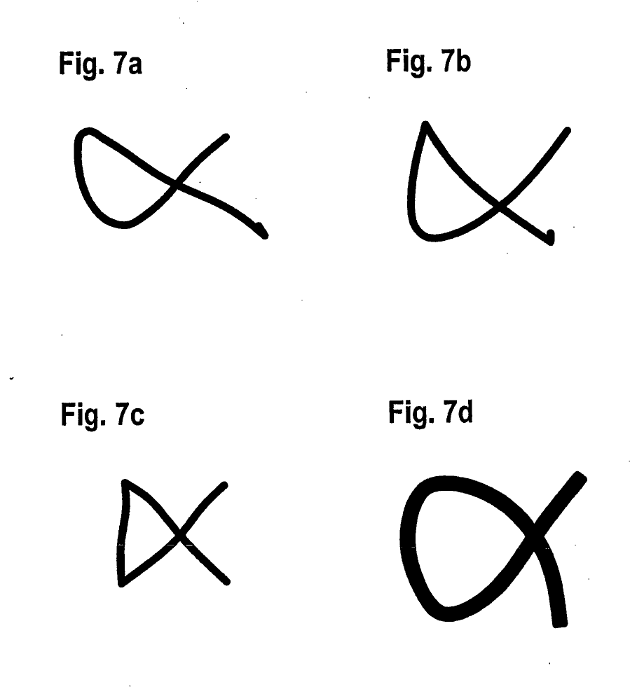

FIGS. 6a-d as well as FIGS. 7a-d show still different embodiments of X-shapes according to variant embodiments of the method.

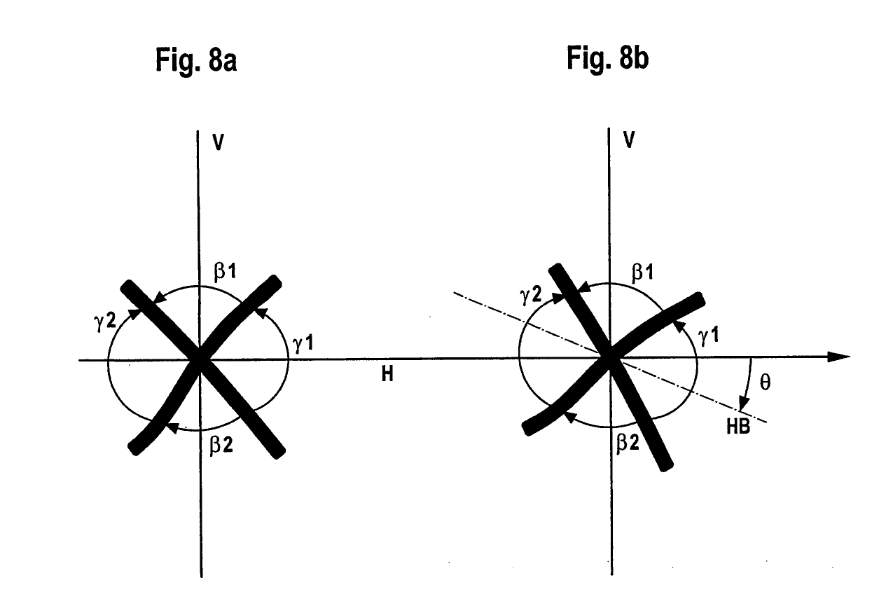

FIGS. 8a-b, 9a-b, 10a-b and 11a-b show different embodiments for X-shapes with different opening and tilting angles around the horizontal axis,

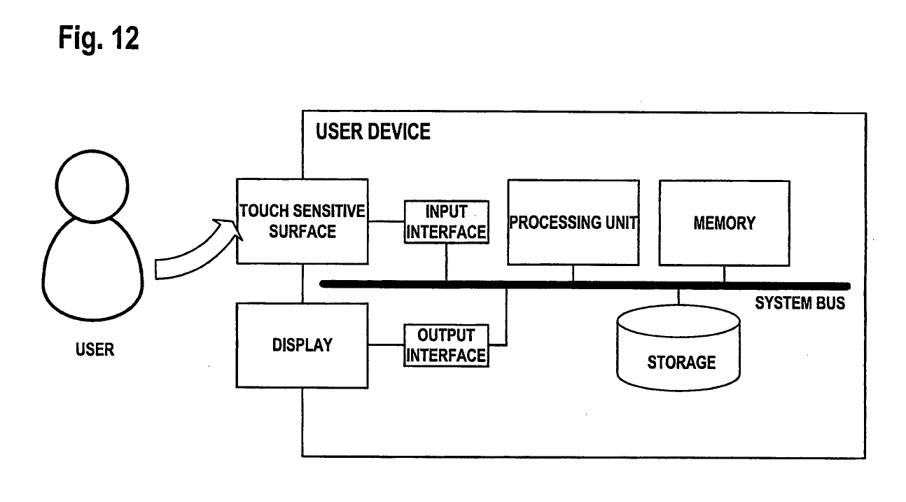

FIG. 12 depicts a user and a high level embodiment of a example of a user device,

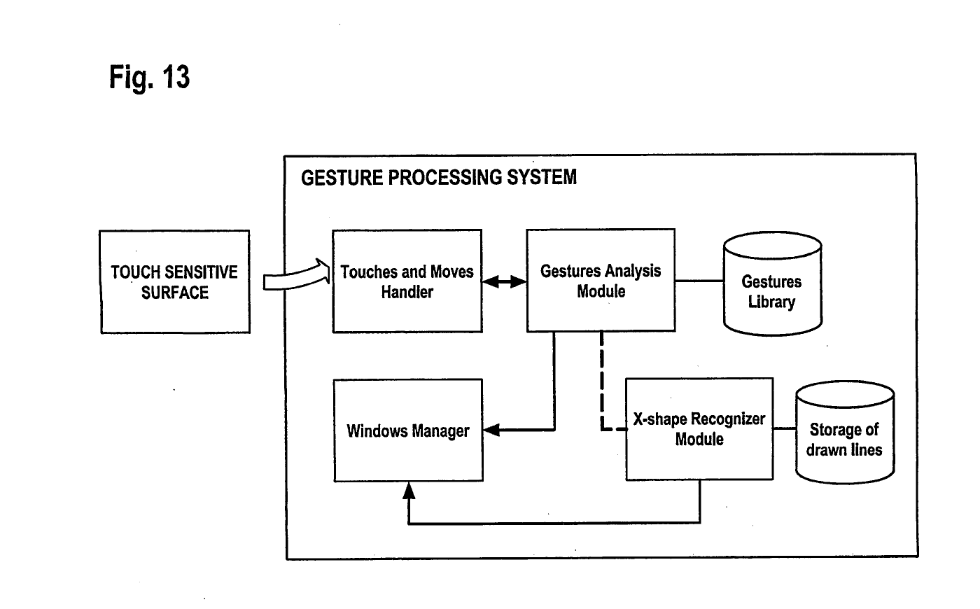

FIG. 13 shows some further details of the gesture processing system of the user device of FIG. 12 and

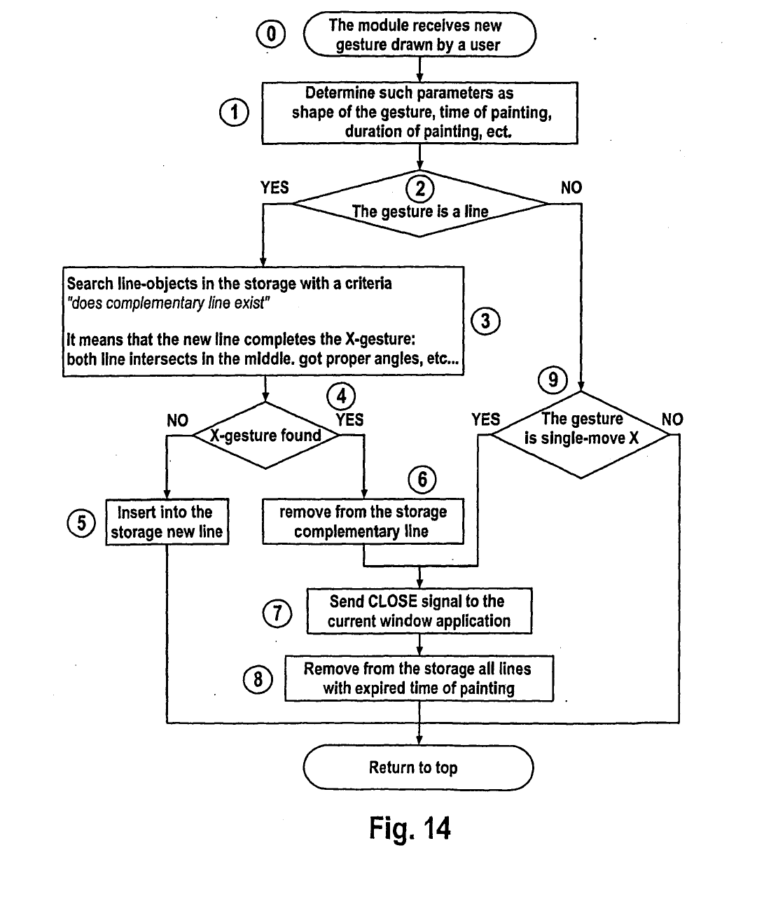

FIG. 14 shows an example flowchart of the steps performed within said processing system.

The functions of the various elements shown in the figures, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) ,random access memory (RAM), and non volatile storage for storing software. Other hardware, conventional and/or custom, may also be included.

A person of skill in the art would also readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

It should also be appreciated by those skilled in the art that any block diagrams in the figures represent conceptual views of illustrative circuitry embodying the principles of the invention. Similarly, it will be appreciated that any flow, charts, flow diagrams, state transition diagrams, pseudo code, and the like represent various processes which may be substantially represented in computer readable medium and so executed by a computer or processor, whether or not such computer or processor is explicitly shown.

In all figures it is further understood that the normal reading position of the touch sensitive input device such as a screen or a touch pad of the user device is depicted, meaning that the screen or pad is not tilted and that the normal reading position of the screen coincides with the position depicted in the figures.

In the following description examples will be mainly given by means of forming an X-shape on a touch sensitive screen. As already mentioned, the method is as well applicable to other embodiments of touch sensitive input devices such as touch pads and the like.

FIG. 1 depicts a first embodiment of the method wherein the gesture of forming an X shape is performed by the sequential sliding over a touch sensitive screen S by a finger in two diagonal directions. The figure shows two windows as displayed on the screen : the active window AW, and another one, denoted W2. With the screen S in a normal reading position the user can form an X-shape by two consecutive sliding actions over the touch screen , in two substantially orthogonal directions, for instance a first sliding action from upper left to down right followed by a next one from upper right to lower left. This order is depicted by the numbers “1” and “2” on the figures. The time in between the two movements can vary from almost zero to one or even a few seconds, depending on the speed of the user forming this sign. So for a young and active user the time between the end of the first sliding action, being the lifting of the finger or stylus, at the end of a diagonal sliding , and the beginning of the next sliding action, being the pushing of the finger or stylus on the screen as indicating the start of the next sliding itself can only take 100 msec, whereas for an older user this can take 1 or even more seconds.

Another example would be to first form the lower right to upper left and then lower left to upper right diagonals for forming the x-shape. Also a gesture comprising a sliding action from first upper right to lower left, followed by a sliding from upper left to lower right, as shown in FIG. 2 is possible. Similarly a gesture comprising a sliding action from lower left to upper right followed by a sliding from upper left to lower right might be possible. Of course all other combinations for forming such a cross or x-like shape using two consecutive sliding actions are possible.

In FIGS. 1 and 2 this gesture is performed within the field of the active window, denoted by AW, which is the one which is generally the most visible such that the second window W2 is partially hiding behind AW. However in some embodiments an active window can only be partially visible or even not be visible at all because it is hiding behind another one, which is not the active window. Also for these embodiments the act of inputting an x-like shape on the touch screen will result in the closing of the active window. Of course the invention is not restricted to only two open windows or screens; in all embodiments with a number of active windows larger or equal than 1, the gesture can be used for closing the active window. In case only one window is open, this is the active window, and this one will accordingly be closed. FIGS. 3 to 5 illustrate the situations wherein the gesture is not performed over the field or screen part related to the active window itself, but in other fields of the screen, either covering the other window W2 as in FIG. 4, either partially covering these two screens AW and W2 as in FIG. 3, or either covering no window at all as in FIG. 5. So it does not matter in these embodiments in which part of the screen the gesture is actually detected, as soon as it is detected it has as consequence that the active window will close. So for the example depicted in FIG. 4, despite the fact that the “X” shape was formed over window W2 and not over the active window AW, still the active window AW will close upon detection of this gesture.

In most cases one of the other windows W2 will become the active window, and the repetition of this same gesture will then lead to closing of that window too. Depending upon the number of active windows , this action can then be repeated by the user until all windows are closed. Finally inputting this gesture after all windows or applications are closed will lead to the closing of the operating system, thus to the shut down of the apparatus itself.

While FIGS. 1 to 5 depict examples whereby the X-shape is generated by means of a user sliding with his/her finger over the touch screen, other means for forming an X-shape on the touch screen can be used, such as by means of a stylus or another suitable item, be it from plastic, wood, metal, stone . . . , for forming such a X-shape on the touch screen or touch pad. Depending on the means for generating the X-shape on the touch sensitive input device, the width of each of the legs of the X can vary from less than a mm, in case a fine stylus is used, to one cm for a user having a thick finger. And combinations where the first leg is generated by a finger sliding action, whereas the second leg of the X is generated e.g. by a stylus sliding over the touch screen in the other direction are also possible, as well as all possible combinations.

Until now only embodiments for detecting a gesture comprising two separate sliding movements for forming the X-shape are described.

However other embodiments are possible wherein only one single movement is used to draw or to generate an X-shape. These are for instance depicted in FIGS. 6a-d and 7a-d. Also X-like shapes which show some tilting with respect to the horizontal axis, as shown in FIGS. 8b,9b,10b are possible. The determination of these different angles, enabling to distinguish such an X-shape form e.g. a +-shape are explained on FIGS. 8a. Therein a nearly perfect X-shape is depicted as the crossing of two substantially orthogonal lines, which respective bisectors coincide with the horizontal and vertical reference axis, coinciding with the horizontal and vertical reference axes of the screen in normal reading position also depicted on the figure as H and V. The respective horizontal opening angles of the X-shape are denoted by γ1 and γ2, as indicated on FIG. 8a, whereas the respective vertical opening angles of the X-shape are denoted by β1 and β2, as also indicated on this figure. In FIG. 8a all angles γ1 and γ2 and β1 and β2 are substantially 90 degrees, indicative of a nearly perfect X-shape.

FIG. 8b shows a slightly tilted X-shape, which is tilted by an tilting angle θ around the X-as. This angle is the angle between the horizontal bisector, denoted by HB, and the horizontal reference axis H. Horizontal as well as vertical opening angles γ1 and γ2 , resp β1 and β2 are still substantially equal to 90 degrees, but the horizontal tilting angle θ is about 20 degrees in this case. Yet this input FIG. 8b is still to be considered as an X-shape by embodiments according to the invention.

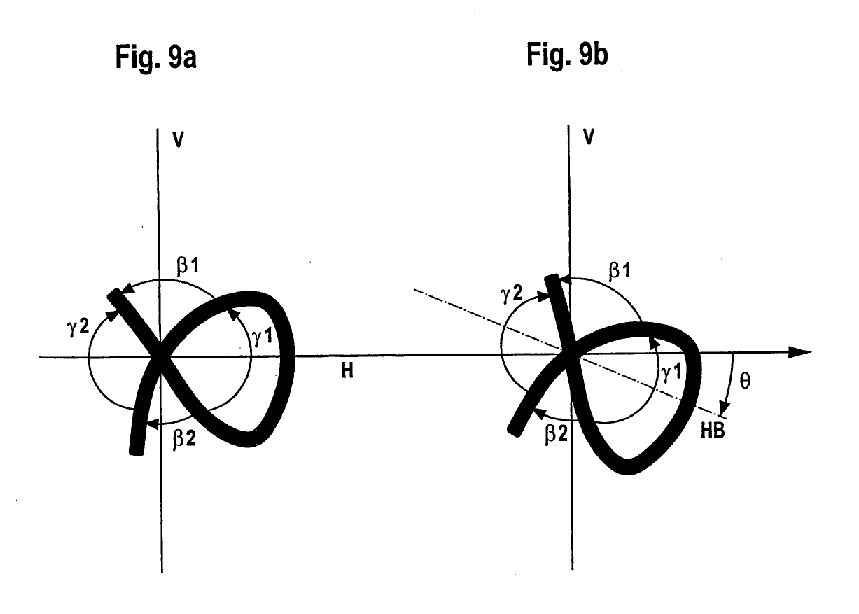

FIG. 9a shows another X-shape, of which the bisectors are still coinciding with the horizontal and vertical reference axes H and V. Horizontal and vertical opening angles are not equal in this embodiment and are deviating from 90 degrees; while the right-hand side horizontal opening angle γ1 is still equal to 90 degrees, the left horizontal opening angle γ2 is 135 degrees. Similarly, the top vertical opening angle β1 is still about 90 degrees, the bottom vertical opening angle β2 is only 55 degrees. FIG. 9b shows the same figure , but again tilted over a tilting angle of 20 degrees.

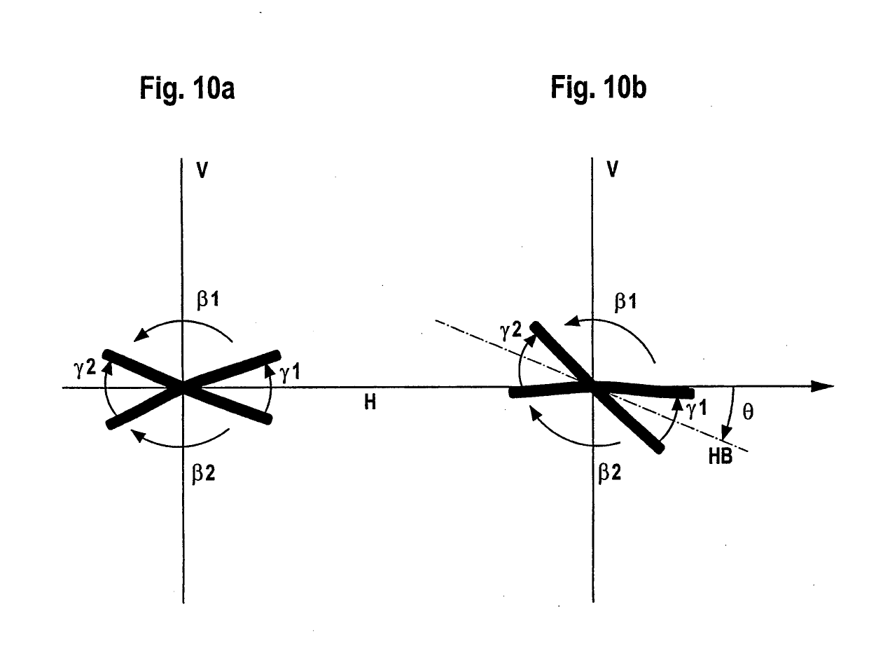

FIG. 10a shows an X-shape of which the bisectors are coinciding with the horizontal and vertical reference axis H and V, and with vertical opening angles of about 135 to 140 degrees, and horizontal opening angles of 40 to 45 degrees. FIG. 10b shows the same X-like shape, but tilted over a horizontal tilting angle 0 of about 22 degrees.

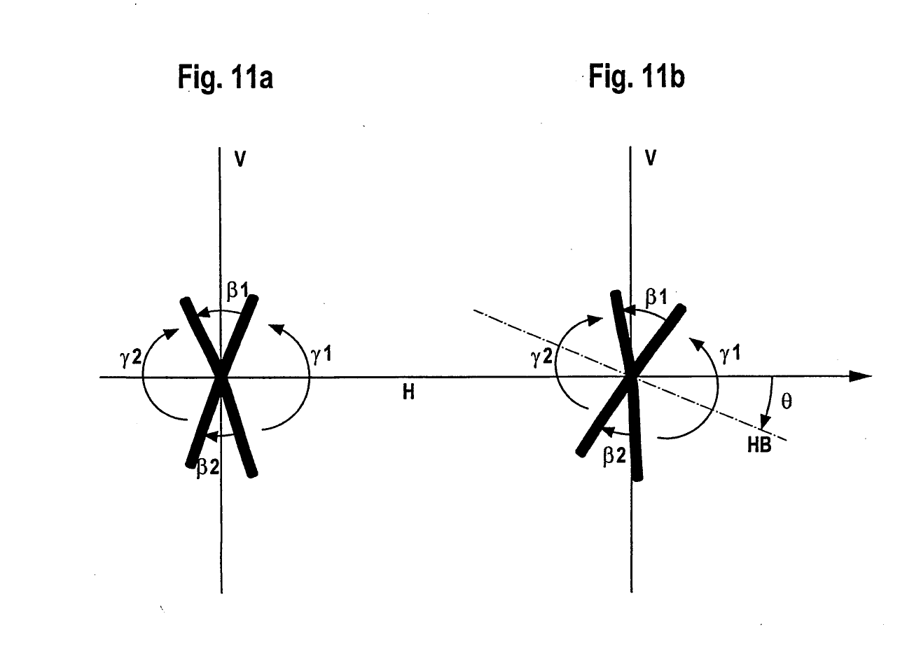

FIG. 11a shows an X-shape of which the bisectors are coinciding with the horizontal and vertical reference axis H and V, and with vertical opening angles of about 40 to 45 degrees, and horizontal opening angles of 135 to 140 degrees. FIG. 10b shows the same X-shape, but tilted over a horizontal tilting angle of about 20 degrees.

In order to enable embodiments according to the invention from still distinguishing X-shapes from e.g. +-like shapes ranges of horizontal and vertical opening angles can be from 30 to 150 degrees, respectively, 150 to 30 degrees; with some preferred ranges between 45 and 135 degrees. The preferred range for the tilting angle may be from 0 to 15 degrees clockwise or counterclockwise, with some larger ranges from 0 to 30 degrees possible, depending on the asymmetry between the horizontal and the vertical opening angles.

Methods and devices for realizing this invention may comprise pressure detectors underneath the touch screen for detecting a single X-formation movement or a sequence of sliding movements by a finger, stylus, or any other object, such as for instance a reversed pencil or pen or even a blunt stone, which may be used for performing a single or a sequence of two sliding movements on a touch sensitive input device.

FIG. 12 shows an embodiment of a user device with some possible building blocks. In this embodiment the touch sensitive surface is separate from the display. This can for instance be the case for touch pads. In other embodiments the touch sensitive surface is incorporated in the screen, but even there the functional part for performing the display function is separate from the functional part for forming the touch input function The user device of FIG. 12 includes a system bus for linking a processing unit, some memory devices represented by “memory” and “storage” and input and output interfaces to the user. FIG. 13 shows a high level block scheme of a gesture processing system which can be implemented on a user device as that of FIG. 12. The embodiment depicted in FIG. 13 includes a gesture analysis module which is coupled to a touches and moves handler, a windows manager , a gesture library and an X-shape recognizer module. The latter device is coupled to a storage device for storage of drawn lines. The Touches and moves handler is the first module adapted to receive signals from the touch sensitive surface.

FIG. 14 shows an exemplary flowchart of the different steps to be performed by the X-shape recognizer module of FIG. 13 in cooperation with the Gesture analysis module of FIG. 13. In this particular embodiment the Gesture Analysis module of FIG. 13 is adapted to analyse activities on the Touch Sensitive Surface in real time. The X-shape detection itself is performed after the drawing or painting is done. In this embodiment the “Gesture Analysis Module” sends gestures to modules like the “X-shape Recognizer” . In case the user device is adapted to recognize some other gestures, other modules can be present, each for detection and analysis of a particular gesture.

The X-shape recognize module, whose functionality is depicted in FIG. 14 by means of the steps performed by it, will in a first step , indicated by block 0, receive a new gesture drawn by a user, from the gesture analysis module. The X-shape recognizer will upon receipt of the gesture, determine parameters such as the shape of the gesture, the time of the painting or drawing action, the time between the previous drawing actions etc. This is indicated by block 1. Upon achieving this step the X-shape recognizer module which will first check, whether or not the X-shape was the results of two separate crossing lines, and in a later phase check whether the X-shape was the result of a single movement gesture, as described in previous paragraphs. Detailed methods for recognition of lines or of shapes are known in the art and will therefore not be further discussed here. A person skilled in the art is adapted to implement them by means of known techniques.

A first analysis whether the input gesture is a line is done by check box denoted 2. If this is the case, a search will be performed within the storage module for an earlier drawn line, within a specific timing constraint of e.g. a few seconds. This is indicated by the block 3. Both lines are combined to check whether a combination of both yields an X-shape, taking into account the tolerances on angles, as explained before. This is also performed in box 3. If indeed an X-shape, based upon the drawing of two separate lines, is recognized, in the step denoted 4, the X-shape recognizer module will inform the gesture analysis module which will send a control signal to the windows manager . The latter will, upon receipt of this signal, accordingly close the active window, as represented by block 7. In parallel or before this, as represented by block 6 in FIG. 14, the X-shape recognizer module, remove the earlier complementary line from the storage module. Upon expiry of a certain time delay, corresponding to a maximum time for receiving the drawing or painting action, all stored lines will be removed in step 8, and there will be a return to the first step. In case the X-gesture was not yet recognized, the X-shape recognizer will store the latest recognized line into the storage device, as represented by step 5.

In case the first analysis whether the input gesture corresponded to a drawn line was negative, a second test will be done, checking whether the input gesture corresponded to the drawing by one single movement of an X-shape. This is represented by step 9. In case a single movement X-shape was indeed recognized, the steps as described for block 7 and 8 are performed, thus closing the active window, and removing from the storage all lines temporarily stored there.

Of course many other embodiments for realizing similar methods on different types of user devices can be envisaged, as well as alternative methods for performing the X-shape recognition in conjunction with the gesture analysis module.

While the principles of the invention have been described above in connection with specific apparatus, it is to be clearly understood that this description is made only by way of example and not as a limitation on the scope of the invention, as defined in the appended claims.

1. Method for closing an active window or an application on a user device via detection of a user input gesture on a touch sensitive input device of said user device, said method comprising:
detecting touch input data with respect to the touch sensitive input device,
interpreting said touch input data, such that, in case said touch input data is recognized as corresponding to a gesture of forming an X-shape on said touch sensitive input device with said touch sensitive input device being oriented in a normal reading position, the active window or running application will be closed.

2. Method according to claim 1 wherein said X-shape is generated by one single movement.

3. Method according to claim 1 wherein said X-shape is generated by a succession of two separate movements.

4. Method according to claim 1 wherein said X-shape has two substantially symmetrical horizontal opening angles ranging between 40 and 140 degrees.

5. Method according to claim 1 wherein after closing of the last active window, upon detecting of another touch input data corresponding to a gesture of forming an X-shape on said touch sensitive input device, the operating system enabling said window to run on a processing unit within said user device, will close.

6. Device programmed to perform the steps of the method in accordance with claim 1.

7. Data storage device for encoding a program for performing the steps of the method according to claim 1, in a machine readable and machine executable form.

8. Downloadable software program for implementing the method in accordance to claim 1.

9. User device comprising a touch sensitive input device for receiving user input touch gestures, and a processing unit configured to run an application or an operating system related to at least one active window, said processing unit being further configured to detect touch input data with respect to said touch sensitive input device and to interpret said touch input data such that, in case said touch input data is recognized as corresponding to a gesture of forming an X-shape on said touch sensitive input device with said touch sensitive input device being oriented in a normal reading position, the active window or running application will be closed.

10. User device according to claim 9 configured to recognize said X-shape upon being generated by one single movement.

11. User device according to claim 9 configured to recognize said X-shape upon being generated by a succession of two separate movements,.

12. User device according to claim 9 configured to recognize said X-shape as comprising two substantially symmetrical horizontal opening angles ranging between 40 and 140 degrees.

13. User device according to claim 9 wherein said processing device is further configured to, after having closed the last active window, upon detecting of another touch input data corresponding to a gesture of forming an X-shape on said touch sensitive input device with said touch sensitive input device being oriented in a normal reading position, to close the operating system.
